(19) United States
(12) Patent Application Publication
(10) Pub. No.: US 2023/0316126 A1
(43) Pub. Date: Oct. 5, 2023

(54) SYSTEM AND METHOD FOR PROVIDING ACCELERATED REINFORCEMENT LEARNING TRAINING

(71) Applicant: Honda Motor Co., Ltd., Tokyo (JP)

(72) Inventors: Ethan K. GORDON, Seattle, WA (US); Rana SOLTANI ZARRIN, Los Gatos, CA (US)

(21) Appl. No.: 17/950,552

(22) Filed: Sep. 22, 2022

Related U.S. Application Data
(60) Provisional application No. 63/325,576, filed on Mar. 30, 2022.

(51) Int. Cl. G06N 20/00

(52) U.S. Cl. CPC G06N 20/00

(57) ABSTRACT

A system and method for providing accelerated reinforcement training that include receiving training data associated with a plurality of atomic actions. The system and method also include inputting the training data associated with the plurality of atomic actions to a neural network. The system and method additionally include completing dynamic programming to generate an optimal policy. The system and method further include inputting the optimal policy through a behavior cloning pipeline to output an expert policy for behavior cloning that is associated with the plurality of atomic actions.

### CROSS-REFERENCE TO RELATED APPLICATION

This application claims priority to U.S. Provisional Application Ser. No. 63/325,576 filed on Mar. 30, 2022, which is expressly incorporated herein by reference.

### BACKGROUND

Deep Reinforcement Learning (DRL) training may involve time intensive processes. Such training may be highly dependent on turning network parameters. Even with a descent tuning of these parameters, generally DRL algorithms may take a long amount of time to converge a policy. In many instances if training time is reduced, policies that are output based on the execution of DRL algorithms are sub optimal and may not be robust enough to be utilized for intended uses.

### BRIEF DESCRIPTION

According to one aspect, a computer-implemented method for providing accelerated reinforcement training. The computer-implemented method may include receiving training data associated with a plurality of atomic actions. The computer-implemented method may also include inputting the training data associated with the plurality of atomic actions to a neural network. The computer-implemented method may additionally include completing dynamic programming to generate an optimal policy. The computer-implemented method may further include inputting the optimal policy through a behavior cloning pipeline to output an expert policy for behavior cloning that is associated with the plurality of atomic actions. At least one computing system is controlled to complete the plurality of atomic actions based on the expert policy.

According to another aspect, a system for providing accelerated reinforcement training. The system may include a memory storing instructions that are executed by a processor. The instructions may include receiving training data associated with a plurality of atomic actions. The instructions may also including input the training data associated with the plurality of atomic actions to a neural network. The instructions may additionally include completing dynamic programming to generate an optimal policy. The instructions may further include inputting the optimal policy through a behavior cloning pipeline to output an expert policy for behavior cloning that is associated with the plurality of atomic actions. At least one computing system is controlled to complete the plurality of atomic actions based on the expert policy.

According to yet another aspect, a non-transitory computer readable storage medium that when executed by a computer, which includes a processor performs a method. The method may include receiving training data associated with a plurality of atomic actions. The method may also include inputting the training data associated with the plurality of atomic actions to a neural network. The method may additionally include completing dynamic programming to generate an optimal policy. The method may further include inputting the optimal policy through a behavior cloning pipeline to output an expert policy for behavior cloning that is associated with the plurality of atomic actions. At least one computing system is controlled to complete the plurality of atomic actions based on the expert policy.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary system 100 for providing accelerated reinforcement learning training according to an exemplary embodiment of the present disclosure;

FIG. 2 is a block diagram illustrating an exemplary planner of the system according to an exemplary embodiment of the present disclosure;

FIG. 3 is a process flow diagram of a method for executing accelerated reinforcement training with respect to grasp sequence planning according to an exemplary embodiment of the present disclosure;

FIG. 4 is a process flow diagram of a method for providing accelerated reinforcement training according to an exemplary embodiment of the present disclosure;

FIG. 5 is an illustration of an example computer-readable medium or computer-readable device including processor-executable instructions configured to embody one or more of the provisions set forth herein according to an exemplary embodiment of the present disclosure; and

FIG. 6 is an illustration of an example computing environment where one or more of the provisions set forth herein are implemented according to an exemplary embodiment of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discreet logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection”, or a connection by which entities are “operably connected”, is one in which signals, physical communications, and/or logical communications may be sent and/or received. An operable connection may include a wireless interface, a physical interface, a data interface and/or an electrical interface.

A “processor”, as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

A “robot system”, as used herein, may be any automatic or manual systems that may be used to enhance the robot, and/or driving. Exemplary robot systems include an autonomous operation system, a stability control system, a brake system, a collision mitigation system, a navigation system, a transmission system, a steering system, one or more visual devices or sensors (e.g., camera systems, proximity sensor systems), a monitoring system, an audio system, a sensory system, a planning system, a grasping system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

System Overview

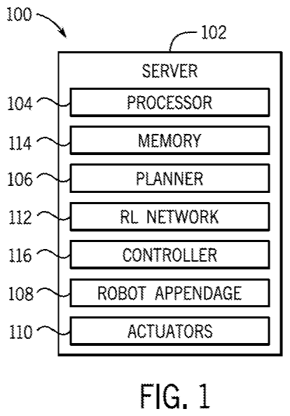

Referring now to the drawings, wherein the showings are for purposes of illustrating one or more exemplary embodiments and not for purposes of limiting the same, FIG. 1 is a schematic view of an exemplary system 100 for providing accelerated reinforcement learning training according to an exemplary embodiment of the present disclosure. The system 100 may include an externally hosted server infrastructure (server) 102 that may include a processor 104 that may be configured to execute a learning-based planner (planner) 106. The planner 106 may be electronically and operably controlled by the processor 104 to learn atomic actions associated with one or more applications.

The present disclosure focuses on an execution of instructions by the system 100 to use the planner 106 to learn atomic actions that are associated with the planning and control of in-hand robotic manipulation of a rigid object. The planning and control of the in-hand manipulation may involve grasp changes that may be implemented through the use of fully-actuated multi-fingered robotic hands that may be included as part of a robot appendage 108 of a robot (not shown). However, it is to be appreciated that the planner 106 may be configured to learn information that may pertain to various types of applications that may include, but may not be limited to, additional robotic applications, vehicular applications, manufacturing applications, mechanical applications, and/or electrical applications.

As discussed in more detail below, the system 100 may be configured to execute a hierarchical RL training framework that may include the utilization of accelerated reinforcement training with respect to grasp sequence planning using the planner 106 to learn a learning-based policy. The learning-based policy may render a hybrid approach that may be more data-efficient than other end-to-end learning approaches.

In this disclosure, a motion planning and control framework for in-hand manipulation associated with the grasp sequence planning is discussed, provided either explicitly as a set of contact points or implicitly as the ability to apply an external wrench to an object by the robot appendage 108. In one embodiment, the robot appendage 108 may include, but may not be limited to a robotic hand and/or a robotic arm, which may include one or more fingers, links, and/or joints. The robot appendage 108 may include actuators 110 which may be configured to drive one or more of the joints, links, or fingers.

In an exemplary embodiment, the server 102 may be operably controlled by the processor 104 to perform processes associated with the execution of a hierarchical RL training framework to provide information to the planner 106 that is analyzed to process a grasp sequence plan that may be output as an expert policy for a new environment. More particularly, the system 100 may be configured input data to a reinforcement learning neural network (RL network) 112 that is hosted on the server 102 to output a stable optimal policy using Dynamic Programming.

The system 100 may be configured to use the optimal policy as a starting policy for an offline environment where the planner 106 learns on top of this policy and processes a grasp sequence plan that is output as an expert policy for a new environment. This expert policy may be utilized to provide one or more commands to electronically control one or more electronic devices (e.g., robot) (not shown) in an execution environment to complete atomic actions such as a grasp sequence. This functionality may provide a training framework which improves data efficiency, stability, and performance of deep reinforcement learning to obtain a policy that may output a grasp change action based on a current object pose.

Accordingly, the system 100 may be configured to first pre-train the RL network 112 with the offline dataset resulted from solving Dynamic Programming on a nominal offline environment to process an optimal policy. The optimal policy may be thereby implemented through a behavior cloning-based pipeline in which the expert policy for the behavior cloning is actually provided by Dynamic Programming. Stated differently, the system 100 may be configured to combine a model based policy which may employ dynamic programming to plan an entire grasp sequence offline given the initial and final grasps with a learning-based policy which may be trained offline to output a sequence of contact addition and removal actions in real time that may be based on an actual object pose to generate an optimal policy. The optimal policy may thereby be used as an input to the planner 106 to be implemented through the behavior cloning-based pipeline to output an expert policy for a new environment (execution environment) that may be utilized to control one or more electronic devices within the execution environment.

In an exemplary embodiment, the processor 104 may be configured to execute one or more applications, operating systems, databases, and the like. The processor 104 may also include internal processing memory, an interface circuit, and bus lines for transferring data, sending commands, and communicating with the plurality of components of the server 102. In one embodiment, the processor 104 may be operably connected to a memory 114 of the server 102. Generally, the processor 104 may communicate with the memory 114 to execute the one or more applications, operating systems, and the like that are stored within the memory 114. In one configuration, the memory 114 may be configured to store the planner 106 and the RL network 112. The memory 114 may additionally be configured to store one or more executable files that are associated with the execution of the hierarchical RL training framework by the system 100 based on electronic processes executed by the processor 104.

In an exemplary embodiment, the plurality of atomic actions that may be performed by the robot appendage 108 may be based on one or more commands that are provided by a controller 116. The controller 116 may be configured to implement the grasp sequence plan included within the expert policy via the robot appendage 108 and one or more actuators 110 to perform the plurality of atomic actions associated with the grasp sequence plan based on one or more commands that are output by the system 100. The plurality of atomic actions may include, but may not be limited to, grasping actions that may be included as part of a grasp sequence of actions that are performed by the robot appendage 108 through the operation of one or more of the actuators 110.

As an illustrative example, the plurality of atomic actions may include grasping actions that may be performed for object manipulation by a robot using a multi-fingered robotic hand with two or more robot fingers in order to change the grasp while maintaining a three-dimensional (3D) force closure to manipulate an object. The object manipulation may employ a model-based approach, by assuming that inertial and kinematic properties of the object and the robot appendage 108, as well as a friction coefficient between the hand links and object may be known. The object manipulation may operate under an assumption that every joint is torque controlled in both directions and that each link of the robotic hand is equipped with a tactile or force-torque sensor that gives a total 3D force and center of pressure of the possibly distributed force applied to the link surface.

In one embodiment, data associated with the plurality of atomic actions may be captured in real-time by one or more cameras (not shown). The one or more cameras may be configured to complete vision based object tracking of the plurality of atomic actions that may be completed in order to complete a grasp sequence by the robot appendage 108 in an offline training environment (not shown). The system 100 may be configured to perform accelerated reinforcement learning training of data associated with the plurality of atomic actions that may pertain to a grasp sequence that is performed to manipulate an object within the training environment as captured by the one or more cameras.

The system 100 may be configured to complete pre-training of the RL network 112 with training data that is provided in the form of image data that is based on images by the one or more cameras or with offline data that may be associated with the plurality of atomic actions captured at one or more time steps in an offline training environment. In one configuration, the system 100 may be configured to input the training data to the RL network 112 to complete Dynamic Programming to obtain an optimal policy that may be further implemented through the behavior cloning-based pipeline and inputted as a starting policy to the planner 106. The planner 106 may thereby process and output an expert policy for behavior cloning that is provided through the Dynamic Programming and associated with a grasp sequence. The grasp sequence plan included within the expert policy may be associated with a plurality of atomic actions to operably control operation of one or more electronic devices such as a robot with a robot appendage 108 within the execution environment.

In one or more embodiments, the expert policy may be utilized by the processor 104 to provide one or more electronic commands to the controller 116 to execute one or more atomic actions to perform a real-time implementation of a grasp sequence. Accordingly, the robot appendage 108 may be operably controlled through one or more of the actuators 110 to perform behavior cloning associated with the plurality of atomic actions that have been captured in images in the offline training environment or previously pre-trained and inputted using dynamic programming as a stable optimal policy and outputted as the expert policy by the planner 106.

The system 100 may thereby provide an improvement to a computer and a technology associated with reinforcement learning training by providing and executing a learning framework where training resources such as time and data may be utilized efficiently and may be put into further exploration, and training on new environments may be improved by the use of dynamic programming. The functionality of pre-training with a stable optimal policy to find and output an expert policy improves efficiency, stability, and performance of reinforcement learning training in comparison to other end-to-end learning approaches. Stated differently, this functionality allows the use of the optimal policy as a starting policy where the on-line RL learns on top of this policy to find an expert policy for the execution environment that may be utilized to control the robot appendage 108 to perform a plurality of atomic actions in a real-world scenario.

As discussed below, the system 100 may be configured to utilize various techniques to make the training process efficient. Accordingly, the system 100 may more efficiently and robustly output an expert policy than other end-to-end learning approaches to generate a plurality of atomic actions that may be indicative of what a desired grasp may be at each time frame during real-time operation of the robot within an online execution environment.

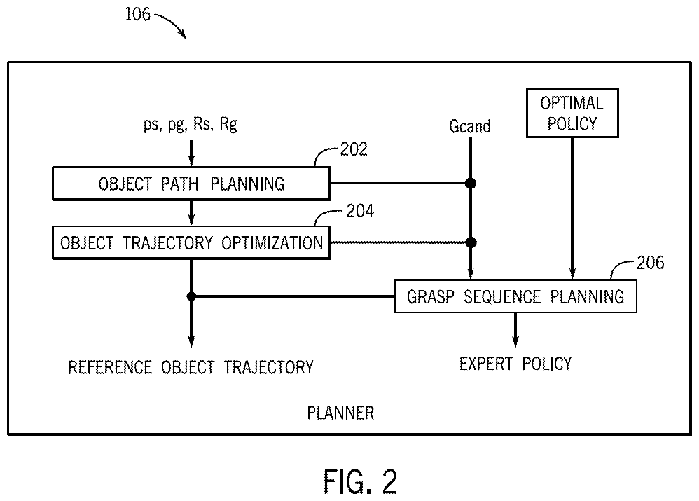

The planner 106 will now be discussed in more detail. FIG. 2 is a block diagram illustrating the planner 106 of the system 100 for object manipulation of FIG. 1, according to one aspect. In an exemplary embodiment, the planner 106 may complete an object path planning 202, object trajectory optimization 204, and a grasp sequence planning 206. The plurality of atomic actions may be determined and executed in two phases based on the inputting of the training data to the RL network 112 and the input of the optimal policy to the planner 106 to implement it through the behavior cloning-based pipeline to learn via on-line Reinforcement Learning on top of the optimal policy to output the expert policy.

The object path planner may perform the object path planning 202, the object trajectory optimization 204, and the grasp sequence planning 206 that is utilized to provide data that is included as part of the expert policy. This disclosure describes the utilization of the reinforcement learning training with respect to grasp sequence planning 206. However, it is to be appreciated that the reinforcement learning training may also or alternatively be utilized for object path planning 202 and/or object trajectory optimization 204.

Object Path Planning

The planner 106 may implement the object path planner to receive an initial object position, a final object position, an initial object orientation, a final object orientation, and a set of grasp candidates. The object path planner may calculate a planned object trajectory based on the initial object position, the final object position, the initial object orientation, the final object orientation, and the set of grasp candidates. As seen in FIG. 2, in one embodiment, the planner 106 may receive one or more inputs of initial object position and final object position pₛ and p_{g}, initial object orientation and final object orientation Rₛ and R_{g}, and the set of grasp candidates G_{cand} and may generate the planned object trajectory based thereon. Thus, the planner 106 may calculate the planned object trajectory based on the initial object position, the final object position, the initial object orientation, the final object orientation, and the set of grasp candidates.

Object Trajectory Optimization

The planner 106 may implement the object trajectory optimizer to receive the planned object trajectory and a set of grasp candidates. As shown in FIG. 2, the planned object trajectory and the set of grasp candidates G_{cand} may be provided to the planner 106. The planner 106 may generate the reference object trajectory based thereon. In other words, the planner 106 may complete object trajectory optimization by receiving the planned object trajectory and the set of grasp candidates and by calculating the reference object trajectory based on the planned object trajectory and the set of grasp candidates.

Grasp Sequence Planning

The planner 106 may implement the grasp sequence planning 206 to generate a grasp sequence. A grasp may include one or more desired contact points for an object and which links or joints of the robot appendage 108 associated with that contact. For example, the robot fingertip of a robotic thumb, the robot fingertip of a robotic index finger, and the robot fingertip of a robotic little finger may be scheduled for contact with the object at three different contact points.

The grasp sequence may be indicative of the kinds of types of grasp the robot appendage 108 may transition through during any in-hand manipulation tasks or phases. Generally, grasps may be very different, and thus, the robot appendage 108 may transition through one or more intermediate grasps between the initial grasp and the final grasp. As shown in FIG. 2, grasp sequence planning may be implemented based on a set of grasp candidates G_{cand} and the expert policy output by the planner 106 to determine the sequence of grasps to connect an initial grasp and a final grasp via one or more intermediary grasps (e.g., a second grasp, a third grasp, etc.) to perform the grasp sequence planning 206 accordingly to output the expert policy for a new environment that may include a grasp sequence.

With continued reference to FIG. 1 and FIG. 2, in one embodiment, the grasp sequence planning 206 function of the planner 106 may be modeled using a Markov Decision Process to solve a grasping manipulation problem to complete grasp changes. Such changes may include, but may not be limited to robotic finger/hand manipulation such as sliding actions, hand manipulative actions, and use of certain robotic fingers to perform grasping functions on an object by the robot appendage 108. This is initially covered by an action space which includes a subset of: {Null, Remove (joint), Add(joint, position), Slide(joint, position)} that indicate not making any changes to joint function, the removal of one or more joints with respect to performing a grasping function, the additional and/or change in function of one or more joints with respect to performing a grasping function, and/or a sliding of fingers to complete a grasping function by the robot appendage 108.

The Markov Decision Process may also include a deterministic transition function in which a reference position/torque follows a fixed trajectory and a contact state is updated directly from the action. In an exemplary embodiment, the grasp sequence planning 206 may be based on a DRL policy that utilizes a reward function. In an exemplary embodiment, since this is a grasping problem, upon receiving the optimal policy, the planner 106 evaluates the feasibility of grasping actions using the reward function. The reward function may be based on a first term indicative of an Inverse Kinematics error (IK error). The IK error may include a goal error of a projected gradient-descent planner for a contact set of the grasp. This considers whether one or more robotic fingers of the robot appendage 108 are reachable to the object to determine whether a grasp is feasible geometrically based on determined contact locations of the grasp.

The reward function may also be based on a second term of a wrench error which pertains to forces that are imparted by contact joints and required forces to counteract gravity, external torque, and object motion along a reference trajectory. The wrench error may consider whether the one or more robotic fingers of the robot appendage 108 are reachable to the object to determine whether a grasp is feasible dynamically, meaning that one or more robotic fingers of the robot appendage 108 may generate forces required to be able to hold the object or realize the object's dynamics at a specific point in time and/or based on the trajectory of the object.

The reward function may also be based on a third term that is indicative of a sliding difficulty that includes a metric that considers sliding distance. The sliding difficulty may consider an action to determine if its a sliding action. In one embodiment, if a sliding action is determined, the sliding action is further analyzed to determine if it is feasible or not. The feasibility determination may consider sliding from a schematics perspective, looking at an inverse schematics error as well as a dynamic feasibility of the sliding action. The dynamic feasibility considers if the sliding action is feasible from the beginning of the sliding action to the end of the sliding action.

The reward function may additionally be based on a fourth term of reward shaping. The reward shaping may penalize (e.g., −2) redundant actions and may more heavily penalize (e.g., −50) infeasible actions such as sliding when not in contact and adding to a different position. In other words, the reward shaping may be completed to output an expert policy that discourages redundant and/or infeasible actions. For example, if a sliding action is not feasible it will be penalized with negative rewards so that it is discouraged from being included as part of the expert policy that is associated with the grasp sequence. Additionally, if a sliding action is redundant it will be penalized with negative rewards so that it is discouraged from being included as part of the expert policy that is associated with the grasp sequence.

In an exemplary embodiment, the reinforcement learning training for generating the expert policy that is output by the planner 106 that is associated with the grasp sequence plan may be carried out with an online-RL based algorithm. In particular, the planner 106 may train the RL network 112 using the an online-RL based algorithm based on the plurality of atomic actions that pertain to the grasp sequence of actions that are completed by the robot appendage 108 based on the operation of the actuators 110.

Efficient Training Approaches:

The system 100 may be configured to provide an efficient training time that includes a shorter period of time to complete training than other end-to-end learning approaches by using one or more solutions, discussed now in more detail.

Caching Reward Results

In one embodiment, the system 100 may be configured to cache reward results as one method of providing an efficient training time to train the RL network 112. The system 100 may be configured to compute reachability of robotic fingers to contact points as part of the reward term. The computation may be completed by executing an inverse kinematic calculation. In particular, the system 100 may perform grasp sequence management by computing where points on the robot finger should be and computing inverse kinematics (IK) to determine joint angles and moving the robot finger accordingly to the desired contact point. The system 100 may change the grasp by adding an additional contact point or removing an existing contact point based on the IK.

Tuning Entropy and Early-Stopping

In one or more embodiments, the system 100 may be configured to tune entropy to select higher values at the beginning of the training to allow more exploration and faster learning and to decrease the values to ensure convergence to the optimal policy as another method of providing an efficient training time to train the RL network 112. The tuning of hyperparameters may play an important role in convergence of the reinforcement learning algorithm to provide the optimal policy. The system 100 may be configured to modify an entropy regularization coefficient and learning rate hyperparameters to select higher values at the beginning of training (0.5 and 5×10⁻⁴) to provide high entropy which encourages exploration. This functionality may be advantageous in the early stages of training to allow more exploration and fast learning. The system 100 may thereby be configured to decrease both parameters linearly as the training progresses to ensure convergence to the optimal policy.

The system 100 may be configured to automate the stepwise reduction of entropy regularization and learning rate and reduce the length of each step. This functionality may yield a policy that is robust enough to be utilized for intended uses that is output based on training that occurs in a time efficient manner.

Action Space Update: Reducing Early Termination

In one embodiment, the system 100 may be configured to modify the action space for the RL agent to ActionSpace={Null, Command(joint, contact)}, where ActionSpace: NULL×Discrete(num_joints)×Discrete(num−contact−positions −per−joint). This functionality may allow the system 100 to use the full possible action set and recover the original policy, while maintaining a reduced training time.

In this new representation joint is the joint (or link) of the finger, and contact is the contact point number for that joint showing the pair of contact point location on the joint and object (both represented in their local frames). Contact points are a discrete set of contact pairs sampled from the continuous points on the object and the links. NULL action is to do nothing, all joints have the action of commanding contact position 0 (no contact or remove contact). All other actions command a joint to go to contact position X, with 1 redundant action per joint if it is already at X the system 100 may penalize that accordingly.

In an illustrative example, the size of action set of a current wrench would be 1 (NULL)+3 (Thumb)+2 (Index 2)+3 (Index 3)+2 (Middle 2)+4 (Middle 3)+2 (Ring 3)=17. Examples of actions from this new action set could be Command M3Y to 0, which means remove M3Y, or Command I3Y to 2, which means add or slide I3Y to the contact location 2. With this updated action space, whether the command is an add or slide is inferred from the current state. For example, Command T3Y to 2 if T3Y is already at contact at 1 means sliding T3Y, while it means adding T3Y if it is currently at contact 0 (i.e. no contact). This action space covers every possible joint transition, has no infeasible actions, and reduces the number of redundant actions. The modified definition of the action space may also increase the average reward of a state-action pair above 0.

Pre-Training Rl with Model-Based Planner Policy

In an exemplary embodiment, the system 100 may be configured to improve the training speed by using a pre-computed policy to pre-train the RL network 112 as discussed above. By using the pre-computing policy to pre-train the RL network 112, the system 100 may provide a catalyst for training that may potentially reduce complexity. In other words, the planner 106 is pre-trained with a stable policy that is added as part of a policy iteration scheme which is utilized as a “hot start” for training. In one configuration, the RL network 112 may be pre-trained with training data that is primarily inputted to the RL network 112 to provide information to start the training of the RL network 112 with off-line data resulted from Dynamic Programming on a nominal environment to provide an efficient training mechanism in comparison to alternate end-to-end learning approaches. This functionality may improve convergence without the need for excessive exploration.

In an exemplary embodiment, the system 100 may complete behavior cloning which focuses on learning the expert policy using supervised learning. The RL network 112 may be configured to utilize Dynamic Programming to compute and generate the optimal policy for each object trajectory. The optimal policy for each object trajectory may thereby be input to the planner 106.

An embodiment of the algorithm and the implementation specifics will now be discussed and will be specific to actor-critic based algorithms. In one embodiment, the Dynamic Programming is utilized to calculate the value ((or equivalently, cost-to-go) for each state, not the individual cost of a given state. The system 100 may be configured to calculate the reward of each transition by calling env.step( ). In some embodiments, this may be the same reward that is used for Reinforcement Learning. The system 100 may then configured to place the reward as the cost of the transition matrix.

The system 100 may thereby be configured to run multiple iterations of Dynamic Programming through the RL network 112 to achieve a total cost-to-go for each state. The system 100 may be configured to determine the sum of all costs taking the optimal policy from a given state until the end and may take the negative of the total cost-to-go for each state to determine the value of the respective state.

The system 100 may thereby be configured to pre-train the RL network 112 with these [state, value] pairs to thereby output the optimal policy as a starting policy for an offline environment for the planner 106 to learn on top of this policy and to process a grasp sequence plan that is output as an expert policy for the new environment. In one or more embodiments, this training framework may be configured to reduce training time and high episode length and return values that may be achieved within shorter period of training time.

Methods Executed by the System

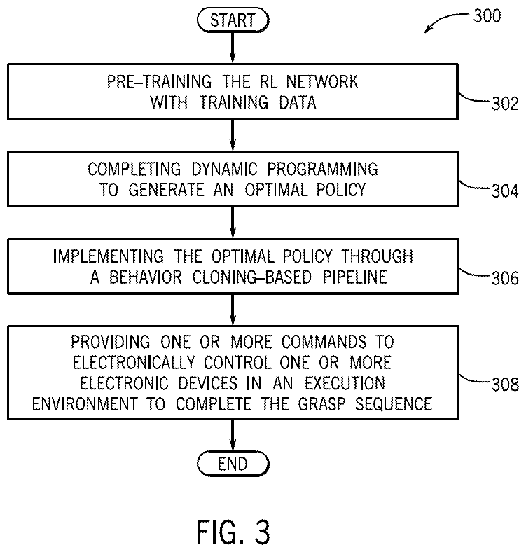

FIG. 3 is a process flow diagram of a method for executing accelerated reinforcement training with respect to grasp sequence planning according to an exemplary embodiment of the present disclosure. FIG. 3 will be described with reference to the components of FIG. 1 and FIG. 2 though it is to be appreciated that the method 300 of FIG. 3 may be used with other systems/components. The method 300 may begin at block 302, wherein the method 300 may include pre-training the RL network 112 with training data.

In an exemplary embodiment, the system 100 may be configured to input training data to the RL network 112 that is provided as an offline dataset that is associated with solving Dynamic Programming on a nominal offline environment that includes a robot. The training data may include a grasp sequence that is associated with the robot appendage 108 that is performed to manipulate an object within the training environment. In another embodiment, the system 100 may be configured to perform accelerated reinforcement learning training of data associated with the plurality of atomic actions that may pertain to a grasp sequence that is performed to manipulate an object within the training environment as captured by the one or more cameras.

The method 300 may proceed to block 304, wherein the method 300 may include completing Dynamic Programming to generate an optimal policy. In an exemplary embodiment, the RL network 112 may be configured to complete Dynamic Programming on the training data. In one configuration, the system 100 may be configured to combine a model based policy which may employ dynamic programming to plan an entire grasp sequence offline given the initial and final grasps with a learning-based policy which may be trained offline within the training environment to output a sequence of contact addition and removal actions in real time that may be based on an actual object pose. The RL network 112 may generate the optimal policy based on the Dynamic Programming and output an optimal policy.

The method 300 may proceed to block 306, wherein the method 300 may include implementing the optimal policy through a behavior cloning-based pipeline. In an exemplary embodiment, upon the RL network 112 outputting the optimal policy, the system 100 may be configured to input the optimal policy to the planner 106. The planner 106 may be configured to implement the optimal policy as a starting policy that is implemented through the behavior cloning-based pipeline. The planner 106 may complete grasp sequence planning 206 that based on a DRL policy that utilizes a reward function. In an exemplary embodiment, upon receiving the optimal policy, the planner 106 may evaluate the feasibility of grasping actions using the reward function. As discussed above, the reward function may be based on numerous terms, including, but not limited to, a first term indicative of an IK error, a second term indicative of a wrench error, a third term that is indicative of a sliding difficulty, and a fourth term that of reward shaping. The planner 106 may thereby be configured to processes a grasp sequence plan that is output as an expert policy for a new environment.

The method 300 may proceed to block 308, wherein the method 300 may include providing one or more commands to electronically control one or more electronic devices in an execution environment to complete the grasp sequence. In an exemplary embodiment, upon the planner 106 outputting the expert policy, the system 100 may be configured to provide one or more commands to the controller 116 to complete the plurality of atomic actions that may be performed by the robot appendage 108 that are based on expert policy to complete the grasp sequence plan. The controller 116 may be configured to implement the grasp sequence plan included within the expert policy via the robot appendage 108 and one or more actuators 110 to perform the plurality of atomic actions associated with the grasp sequence plan based on one or more commands that are output by the system 100.

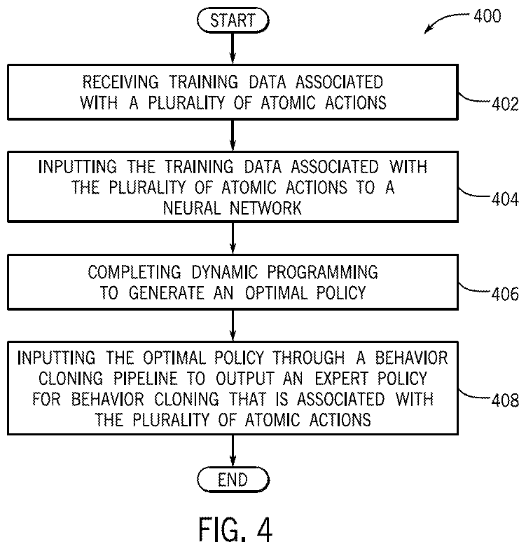

FIG. 4 is a process flow diagram of a method 400 for providing accelerated reinforcement training according to an exemplary embodiment. The method 400 may begin at block 402, wherein the method 400 may include receiving training data associated with a plurality of atomic actions.

The method 400 may proceed to block 404, wherein the method 400 may include inputting the training data associated with the plurality of atomic actions to a neural network. The method 400 may proceed to block 406, wherein the method 400 may include completing dynamic programming to generate an optimal policy. The method 400 may proceed to block 408, wherein the method 400 may include inputting the optimal policy through a behavior cloning pipeline to output an expert policy for behavior cloning that is associated with the plurality of atomic actions. In one embodiment, at least one computing system is controlled to complete the plurality of atomic actions based on the expert policy.

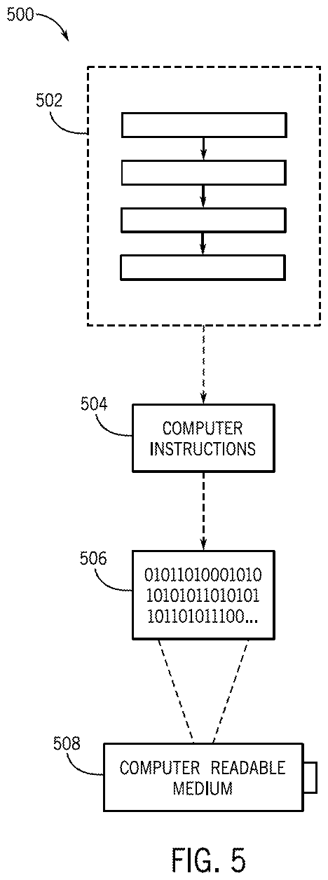

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the method 300 of FIG. 3 and/or the method 400 of FIG. 4. In another aspect, the processor-executable computer instructions 504 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

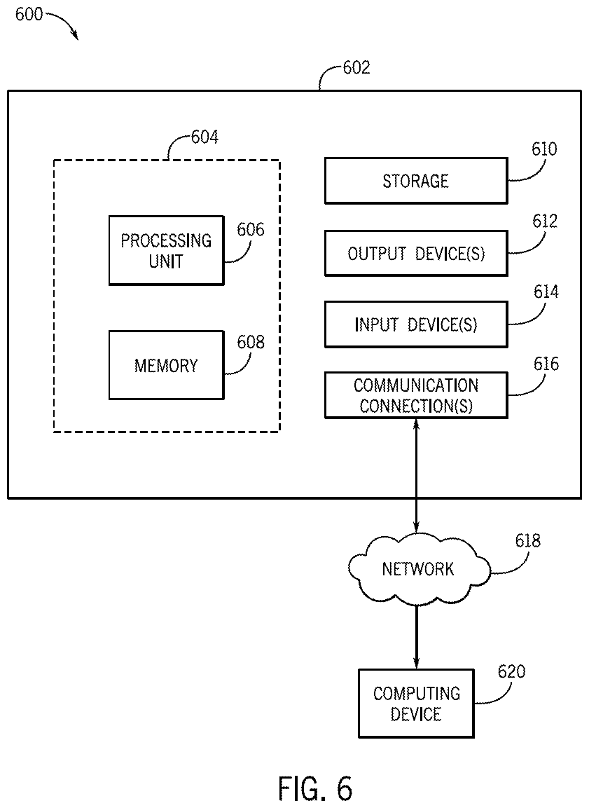

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 602 configured to implement one aspect provided herein. In one configuration, the computing device 602 includes at least one processing unit 606 and memory 608. Depending on the exact configuration and type of computing device, memory 608 may be volatile, such as RAM, non-volatile, such as ROM, flash memory, etc., or a combination of the two. This configuration is illustrated in FIG. 6 by dashed line 604.

In other aspects, the computing device 602 includes additional features or functionality. For example, the computing device 602 may include additional storage such as removable storage or non-removable storage, including, but not limited to, magnetic storage, optical storage, etc. Such additional storage is illustrated in FIG. 6 by storage 600. In one aspect, computer readable instructions to implement one aspect provided herein are in storage 610. Storage 610 may store other computer readable instructions to implement an operating system, an application program, etc. Computer readable instructions may be loaded in memory 608 for execution by processing unit 606, for example.

The term “computer readable media” as used herein includes computer storage media. Computer storage media includes volatile and nonvolatile, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 602. Any such computer storage media is part of the computing device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 602 includes input device(s) 614 such as keyboard, mouse, pen, voice input device, touch input device, infrared cameras, video input devices, or any other input device. Output device(s) 612 such as one or more displays, speakers, printers, or any other output device may be included with the computing device 602. Input device(s) 614 and output device(s) 612 may be connected to the computing device 602 via a wired connection, wireless connection, or any combination thereof. In one aspect, an input device or an output device from another computing device may be used as input device(s) 614 or output device(s) 612 for the computing device 602. The computing device 602 may include communication connection(s) 616 to facilitate communications with one or more other devices 620, such as through network 618, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for providing accelerated reinforcement training comprising:
receiving training data associated with a plurality of atomic actions;
inputting the training data associated with the plurality of atomic actions to a neural network;
completing dynamic programming to generate an optimal policy; and
inputting the optimal policy through a behavior cloning pipeline to output an expert policy for behavior cloning that is associated with the plurality of atomic actions, wherein at least one computing system is controlled to complete the plurality of atomic actions based on the expert policy.

2. The computer-implemented method of claim 1, wherein receiving training data includes receiving at least one of: an offline dataset that is associated with the plurality of atomic actions captured at particular time steps in an offline training environment and image data that is based on images by at least one camera that is associated with the plurality of atomic actions captured at particular time steps in the offline training environment.

3. The computer-implemented method of claim 1, wherein inputting the training data to the neural network includes inputting the training data to a Reinforcement Learning network to complete dynamic programming and output the optimal policy as a starting policy for an offline environment.

4. The computer-implemented method of claim 1, wherein inputting the optimal policy through the behavior cloning pipeline includes inputting the optimal policy to a learning-based planner to learn the plurality of atomic actions that are associated with a grasp sequence.

5. The computer-implemented method of claim 4, wherein the grasp sequence includes grasp changes that are implemented through fully-actuated multi-fingered robotic hands that are included as part of a robot appendage of a robot and pertain to an in-hand robotic manipulation of a rigid object.

6. The computer-implemented method of claim 5, wherein the learning-based planner evaluates a feasibility of grasping actions using a reward function, wherein the reward function is based on at least one of: a first term indicative of an Inverse Kinematics error, a second term indicative of a wrench error which pertains to forces that are imparted by contact joints and required forces to counteract gravity, external torque, and object motion along a reference trajectory, a sliding difficulty that includes a metric that considers sliding distance, and reward shaping that penalizes infeasible and redundant actions.

7. The computer-implemented method of claim 6, wherein the learning-based planner outputs the expert policy that is associated with the plurality of atomic actions that pertain to a grasp sequence plan to be performed in an execution environment.

8. The computer-implemented method of claim 7, wherein at least one command is communicated to a controller to implement the grasp sequence plan included within the expert policy through the robot appendage to perform the plurality of atomic actions associated with the grasp sequence plan.

9. The computer-implemented method of claim 1, further including executing accelerated reinforcement training by completing at least one of: caching reward results by executing an inverse kinematic calculation, turning entropy to select higher values at a beginning of training and decrease the values to ensure convergence to the optimal policy, and modifying an action space to use a full possible action set to cover every possible joint transition and reduce a number of redundant actions.

10. A system for providing accelerated reinforcement training comprising:
a memory storing instructions when executed by a processor cause the processor to:
receive training data associated with a plurality of atomic actions;
input the training data associated with the plurality of atomic actions to a neural network;
complete dynamic programming to generate an optimal policy; and
input the optimal policy through a behavior cloning pipeline to output an expert policy for behavior cloning that is associated with the plurality of atomic actions, wherein at least one computing system is controlled to complete the plurality of atomic actions based on the expert policy.

11. The system of claim 10, wherein receiving training data includes receiving at least one of: an offline dataset that is associated with the plurality of atomic actions captured at particular time steps in an offline training environment and image data that is based on images by at least one camera that is associated with the plurality of atomic actions captured at particular time steps in the offline training environment.

12. The system of claim 10, wherein inputting the training data to the neural network includes inputting the training data to a Reinforcement Learning network to complete dynamic programming and output the optimal policy as a starting policy for an offline environment.

13. The system of claim 10, wherein inputting the optimal policy through the behavior cloning pipeline includes inputting the optimal policy to a learning-based planner to learn the plurality of atomic actions that are associated with a grasp sequence.

14. The system of claim 13, wherein the grasp sequence includes grasp changes that are implemented through fully-actuated multi-fingered robotic hands that are included as part of a robot appendage of a robot and pertain to an in-hand robotic manipulation of a rigid object.

15. The system of claim 14, wherein the learning-based planner evaluates a feasibility of grasping actions using a reward function, wherein the reward function is based on at least one of: a first term indicative of an Inverse Kinematics error, a second term indicative of a wrench error which pertains to forces that are imparted by contact joints and required forces to counteract gravity, external torque, and object motion along a reference trajectory, a sliding difficulty that includes a metric that considers sliding distance, and reward shaping that penalizes infeasible and redundant actions.

16. The system of claim 15, wherein the learning-based planner outputs the expert policy that is associated with the plurality of atomic actions that pertain to a grasp sequence plan to be performed in an execution environment.

17. The system of claim 16, wherein at least one command is communicated to a controller to implement the grasp sequence plan included within the expert policy through the robot appendage to perform the plurality of atomic actions associated with the grasp sequence plan.

18. The system of claim 10, further including executing accelerated reinforcement training by completing at least one of: caching reward results by executing an inverse kinematic calculation, turning entropy to select higher values at a beginning of training and decrease the values to ensure convergence to the optimal policy, and modifying an action space to use a full possible action set to cover every possible joint transition and reduce a number of redundant actions.

19. A non-transitory computer readable storage medium storing instructions that when executed by a computer, which includes a processor performs a method, the method comprising:
receiving training data associated with a plurality of atomic actions;
inputting the training data associated with the plurality of atomic actions to a neural network;
completing dynamic programming to generate an optimal policy; and
inputting the optimal policy through a behavior cloning pipeline to output an expert policy for behavior cloning that is associated with the plurality of atomic actions, wherein at least one computing system is controlled to complete the plurality of atomic actions based on the expert policy.

20. The non-transitory computer readable storage medium of claim 19, further including executing accelerated reinforcement training by completing at least one of: caching reward results by executing an inverse kinematic calculation, turning entropy to select higher values at a beginning of training and decrease the values to ensure convergence to the optimal policy, and modifying an action space to use a full possible action set to cover every possible joint transition and reduce a number of redundant actions.
